(19) United States
(12) Patent Application Publication
(10) Pub. No.: US 2007/0089148 A1
(43) Pub. Date: Apr. 19, 2007

(54) Apparatus for providing supplementary function of digital multimedia broadcasting and method of the same

(75) Inventors: Ui-taek Oh, Suwon-si (KR); Houk Wang, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/546,401

(22) Filed: Oct. 12, 2006

(30) Foreign Application Priority Data
Oct. 17, 2005 (KR) 2005-97590

(51) Int. Cl. H04N 7/173; H04N 7/16

(52) U.S. Cl. 725/90; 725/132; 725/140; 725/100

(57) ABSTRACT

An apparatus for providing a supplementary function of digital multimedia broadcasting includes a control unit that receives a selected instruction message for a digital multimedia broadcasting signal input by a user, a demodulating unit that receives a digital multimedia broadcasting signal corresponding to the selected instruction message by using at least one tuner, a reception sensitivity confirming unit that confirms the reception sensitivity of the received digital multimedia broadcasting signal, and a determining unit that determines whether the received digital multimedia broadcasting signal is output in accordance with the confirmed reception sensitivity.

### CROSS-REFERENCE TO RELATED APPLICATION

This application claims priority from Korean Patent Application No. 2005-97590 filed on Oct. 17, 2005 in the Korean Intellectual Property Office, the disclosure of which is incorporated herein by reference in its entirety.

### BACKGROUND OF THE INVENTION

1. Field of the Invention

Aspects of the present invention relates to an apparatus for providing a supplementary function of digital multimedia broadcasting and a method of the same, and more particularly, to an apparatus for providing a supplementary function of digital multimedia broadcasting and a method of the same, in which a plurality of tuners for receiving digital multimedia broadcasting are provided, and reception of digital multimedia broadcasting through one ensemble and measurement of reception sensitivity of another ensemble are simultaneously performed.

2. Description of the Related Art

In general, digital multimedia broadcasting (hereinafter, referred to as DMB) provides CD (compact disc)-level sound quality and data or video services, and high-level fixed and mobile reception quality. Such DMB service is also classified into two types on the basis of a transmission mechanism (terrestrial-wave or satellite): terrestrial-wave DMB and satellite DMB. Therefore, the DMB refers to high-quality digital multimedia broadcasting services that provide various digital contents to fixed receivers and moving cellular phone subscribers through economical broadcasting networks.

The terrestrial-wave DMB provides music and video services by using a terrestrial repeater. In accordance with usable frequencies, the terrestrial-wave DMB is classified into two types; an in-band type and an out-of-band type. The in-band type uses existing AM/FM bands, and the out-of-band type allocates new frequency bands for use. In this case, the in-band type includes an IBOC (In Band On Channel) method in the United States of America, which uses the existing AM/FM channels, and an IBAC (In Band Adjacent Channel) method, which uses channels adjacent to the existing FM channels. The out-of-band type includes a Eureka-147 method in Europe and an ISDB-T method in Japan.

A received bit rate of the terrestrial-wave DMB is approximately 384 or 526 kbps. Additionally, MPEG-4, which has better compression efficiency than MPEG-2 used in a terrestrial-wave digital TV, is used as a video service compression code of the terrestrial-wave DMB. The terrestrial-wave DMB uses an orthogonal frequency division multiplexing (OFDM) transmission method that transmits signals through multiple carrier waves. The OFDM method is effective in multiple path propagation, which has an advantage in mobile reception.

The satellite DMB provides services within a band of 2.535 to 2.655 GHz that corresponds to ultrahigh frequencies (UHFs) within a higher frequency band than the terrestrial-wave. The terrestrial-wave DMB provides services by sending electric waves from transmitting stations provided on the ground, while the satellite DMB provides services over a wider range by sending electric waves from the satellite outside the atmosphere to the ground.

Analog broadcasting can send one program within one frequency band. In contrast, digital broadcasting can send multiple programs within one frequency by multiplexing. In this case, a multiplexed broadcasting stream is referred to as an ensemble. In the case of DMB, one ensemble includes data, such as an audio stream that is encoded with Musicam (MPEG-1 layer-2), an A/V stream and a DLS (Dynamic Label Service) that are encoded with MPEG-4 and included in a transport stream of MPEG-2 so as to be transmitted. The data can also be a BWS (Broadcast Web Site), a JPEG slide show, a TPEG (Transport Protocol Expert Group), or the like.

FIG. 1 is a diagram illustrating ensembles 11, 12, and 13 included in one channel of conventional terrestrial-wave channels. The ensembles 11, 12, and 13 have a bandwidth of 1.536 MHz and are included in terrestrial-wave 10 frequencies of a bandwidth of 204 to 210 MHz. One ensemble (any one of the ensembles 11, 12, and 13) may include contents according to various combinations of video, audio and data services within a maximum bandwidth of 1.152 Mbps. In this case, the types of the included contents depend on service providers.

As compared to the analog broadcasting, the digital broadcasting multiplexes different types of contents and sends the multiplexed contents through one frequency band. Therefore, a DMB terminal should support various different decoding modules in accordance with types of contents includable in the ensembles.

The DMB terminal receives frames that are transmitted at a predetermined transmitting cycle (96 ms in Korea). In this case, each frame includes a synchronization channel (hereinafter, referred to as SC) field, a fast information channel (hereinafter, referred to as FIC) field, and a main service channel (hereinafter, referred to as MSC) field. The SC field refers to a field that indicates a starting location of the frame, and is used for frame synchronization. The FIC field refers to a field that includes configuration information and service information of the ensemble. The MSC field refers to a field that includes contents, and has a plurality of logical sub-channels in accordance with configuration contents of the ensemble.

After the DMB terminal tunes a frequency, the DMB terminal analyzes data included in the FIC. The DMB terminal confirms the logical configuration information of the MSC, and stores information or performs a specific function by using the logical configuration information of the MSC and other service information. As such, the DMB terminal tunes a frequency to one of a plurality of ensembles included in one frequency band. The DMB terminal outputs a content selected by a user among contents included in the one ensemble and the reception intensity of the tuned ensemble. At this time, in order to output the reception intensity of another ensemble other than the currently tuned ensemble or a content included in another ensemble, the DMB terminal should tune a frequency to another ensemble. In addition, since the DMB terminal provides only one content, it is not possible to provide contents included in different ensembles at the same time.

FIG. 2 is a diagram illustrating reception sensitivity of ensembles supplied by different conventional digital multimedia broadcasting providers. As shown in FIG. 2, each of the different digital multimedia broadcasting providers transmits a digital multimedia a broadcasting signal having a different capacity. Therefore, the reception sensitivity of the ensembles 21, 22, and 23, which are received by the DMB apparatus, is different while depending on the digital multimedia broadcasting providers and environmental conditions of the DMB apparatus.

Korean Patent Publication No. 10-2004-0100171 discloses a digital multimedia broadcasting receiving apparatus having multiple tuners and a system that receives and processes signals transmitted through the tuners with a digital multimedia broadcasting type are separately provided. The digital multimedia broadcasting receiving apparatus has a dual broadcasting output function of outputting digital multimedia broadcasting signals received according to the selection of users. However, according to such a digital multimedia broadcasting receiving apparatus, only the broadcasting signals received through the plurality of tuners are output. Thus, it is not possible to output the reception intensity of ensembles to which frequencies the receiving apparatus is not tuned. That is, since the receiving apparatus outputs one or a plurality of broadcasting signals whose reception intensity is weak, the user must still tune frequencies again so as to search for ensembles having excellent reception intensity. Accordingly, a method of providing optimal information to users who want to be provided with contents of ensembles having excellent reception intensity through the DMB terminal is required.

### SUMMARY OF THE INVENTION

An aspect of the present invention provides an apparatus for providing a supplementary function of digital multimedia broadcasting and a method of the same, in which a plurality of tuners for receiving digital multimedia broadcasting are provided, and reception of digital multimedia broadcasting through one ensemble and measurement of reception sensitivity of another ensemble are simultaneously performed.

Another aspect of the present invention provides an apparatus for providing a supplementary function of digital multimedia broadcasting and a method of the same, in which the reception sensitivity of another ensemble that does not include the content can be measured by using another tuner that is not used for content reception, and when the measured reception sensitivity is equal to or greater than a predetermined threshold value, it is possible to inform a user that the measured reception sensitivity is equal to or greater than the predetermined threshold value.

According to an aspect of the invention, an apparatus for providing a supplementary function of digital multimedia broadcasting includes a control unit that receives a selected instruction message for a digital multimedia broadcasting signal input by a user, a demodulating unit that receives a digital multimedia broadcasting signal corresponding to the selected instruction message by using at least one tuner, a reception sensitivity confirming unit that confirms the reception sensitivity of the received digital multimedia broadcasting signal, and a determining unit that determines whether the received digital multimedia broadcasting signal is output in accordance with the confirmed reception sensitivity.

According to another aspect of the invention, a method of providing a supplementary function of digital multimedia broadcasting includes receiving a selected instruction message for a digital multimedia broadcasting signal input by a user, receiving a digital multimedia broadcasting signal corresponding to the selected instruction message by using at least one tuner, confirming the reception sensitivity of the received digital multimedia broadcasting signal, and determining whether the received digital multimedia broadcasting signal is output in accordance with the confirmed reception sensitivity.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram illustrating ensembles included in one channel of conventional terrestrial-wave channels;

FIG. 2 is a diagram illustrating reception sensitivity of ensembles supplied by conventional different digital multimedia broadcasting providers;

FIG. 3 is a conceptual view illustrating primary roles of an apparatus for providing a supplementary function of digital multimedia broadcasting according to an embodiment of the invention;

FIG. 4 is a block diagram illustrating an apparatus for providing a supplementary function of digital multimedia broadcasting according to an embodiment of the invention;

FIG. 5 is a diagram illustrating a selected instruction message according to an embodiment of the invention;

FIG. 6 is a diagram illustrating a type in which digital multimedia broadcasting is output in accordance with an embodiment of the invention;

FIG. 7 is a diagram illustrating a type in which a notification message is output in accordance with an embodiment of the invention; and

FIG. 8 is a flowchart illustrating a process for supplying a supplementary function of digital multimedia broadcasting according to an embodiment of the invention.

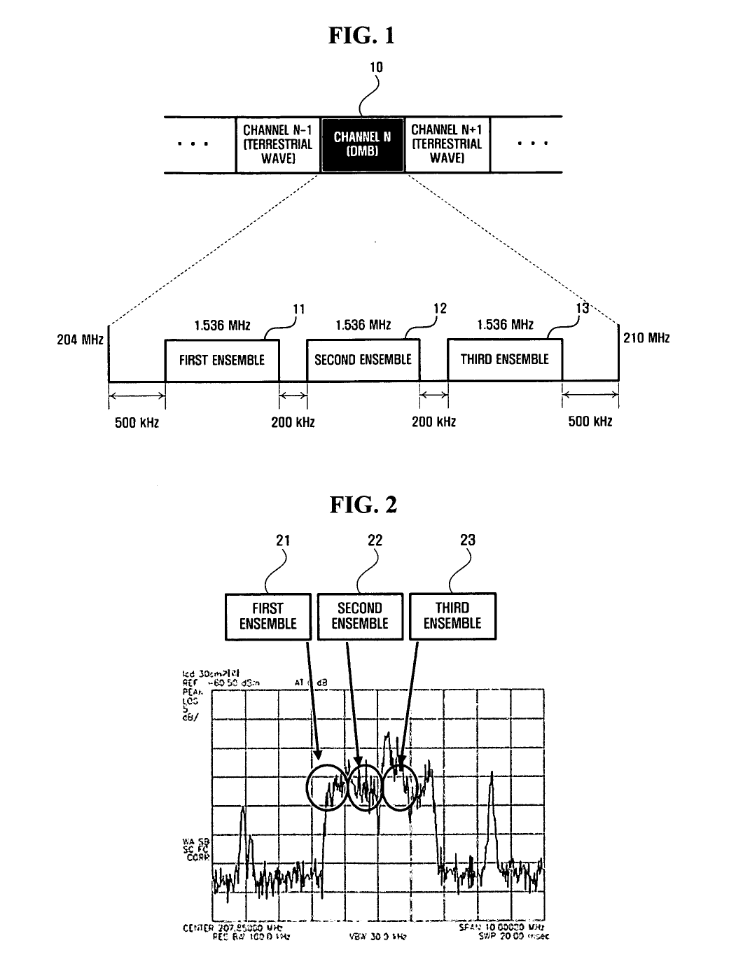

### DETAILED DESCRIPTION OF THE EMBODIMENTS

Advantages and features of aspects of the present invention and methods of accomplishing the same may be understood more readily by reference to the following detailed description of embodiments and the accompanying drawings, wherein like reference numerals refer to the like elements throughout. Aspects of the present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

While not required in all aspects, one or more of the blocks in the accompanying block diagrams and compositions of steps in the flow charts can be performed by computer program instructions. These computer program instructions can be provided to processors of, for example, general-purpose computers, special-purpose computers, and programmable data processing apparatuses. Therefore, the instructions performed by the computer or the processors of the programmable data processing apparatus generate means for executing functions described in the blocks in block diagrams or the steps in the flow charts. The computer program instructions can be stored in a computer available memory or a computer readable memory of the computer or the programmable data processing apparatus in order to realize the functions in a specific manner. Therefore, the instructions stored in the computer available memory or the computer readable memory can manufacture products including the instruction means for performing the functions described in the blocks in the block diagrams or the steps in the flow charts. Also, the computer program instructions can be loaded onto the computer or the computer programmable data processing apparatus. Therefore, a series of operational steps is performed in the computer or the programmable data processing apparatus to generate a process executed by the computer, which makes it possible for the instructions driving the computer or the programmable data processing apparatus to provide steps of executing the functions described in the blocks of the block diagrams or the steps of the flow charts.

Each block or each step may indicate a portion of a module, a segment or a code including one or more executable instructions for performing a specific logical function (or functions). It should be noted that, in some modifications of the invention, the functions described in the blocks or the steps may be generated out of order. For example, two blocks or steps continuously shown can be actually performed at the same time, or they can be performed sometimes in reverse order according to the corresponding functions.

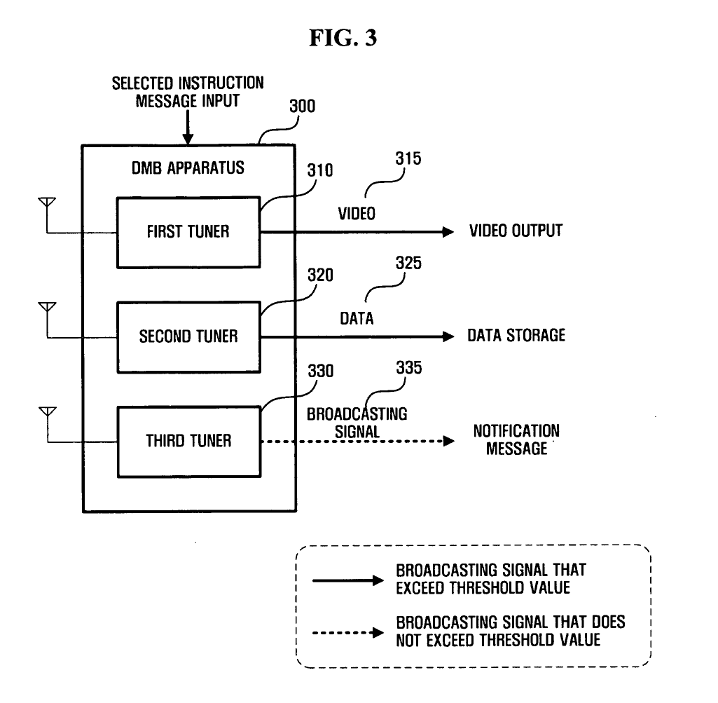

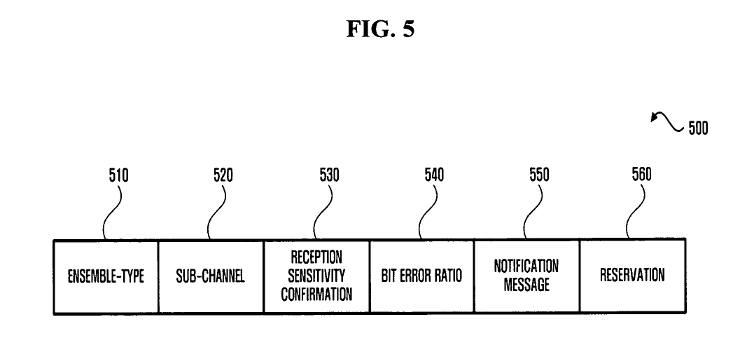

FIG. 3 is a conceptual view illustrating primary roles of an apparatus for providing a supplementary function of digital multimedia broadcasting according to an embodiment of the invention. The apparatus 300 (hereinafter, referred to as DMB apparatus) for providing a supplementary function of digital multimedia broadcasting (DMB) receives a selected instruction message for specific digital multimedia broadcasting that is input by a user. In this case, the selected instruction message includes information. Examples of such information include, but are not limited to, an ensemble-type field, a sub-channel field, a reception sensitivity confirmation field, a bit error ratio field, a notification message field, and/or a reservation field. The detailed description for the selected instruction message will be described below with reference to FIG. 5.

The DMB apparatus 300 includes tuners 310, 320, and 330 so as to receive a plurality of digital multimedia broadcasting signals. Therefore, the users can input a plurality of selected instruction messages. After the selected instruction messages are input to the DMB apparatus 300 by the users, the DMB apparatus 300 receives digital multimedia broadcasting signals according to the selected instruction messages through the tuners 310, 320, and 330 that are provided therein. FIG. 3 illustrates the DMB apparatus 300 that includes three tuners 310, 320, and 330. In an aspect of the invention, the users input to the DMB apparatus 300 selected instruction messages for video reception, data reception, and confirmation of reception sensitivity in real time. While shown with three tuners, other numbers of turners can be used, and that there do not need to be equal numbers of tuners receiving video, data, and/or confirmation.

In accordance with the selected instruction message input by the user, the first tuner 310 of the DMB apparatus 300 is tuned to a frequency corresponding to a sub-channel of a specific ensemble so as to receive a video signal 315. The second tuner 320 is tuned to a frequency corresponding to a sub-channel of another ensemble so as to receive data signal 325. The third tuner 330 is tuned to a frequency corresponding to a sub-channel of further another ensemble so as to receive a specific digital multimedia broadcasting signal 335 in real time. In this example, the dashed lines of the specific digital multimedia broadcasting signal 335 indicates that the signal 335 has very small reception sensitivity as an audio signal, a video signal or a data signal, and thus cannot be properly processed by the DMB apparatus 300. Therefore, the DMB apparatus 300 confirms the reception sensitivity in real time.

The DMB apparatus 300 shown in FIG. 3 receives the three contents 315, 325, and 335 through the three tuners 310, 320, and 330. Thus, the apparatus 300 can simultaneously perform video output, data storage, and confirmation of the reception sensitivity for the specific digital multimedia broadcasting signal. However, it is understood that the other numbers of contents can be tuned and/or processed, and that fewer numbers of tuners can be used to the extent one tuner is available for contents and another tuner used to detect reception sensitivity for other signals. Additionally, it is understood that other types of data can be in the signals instead of or in addition to video and data, such as audio data.

In FIG. 3, the solid lines and the dotted line indicates the reception sensitivity of the digital multimedia broadcasting signal. Specifically, the solid lines indicate that the reception sensitivity of the corresponding signal (i.e. video 315, data 325) exceeds a predetermined threshold value. The dotted line indicates that the reception sensitivity of the corresponding signal (i.e. content 335) does not exceed a predetermined threshold value. That is, since the reception sensitivity of each of the video 315 and the data 325, which has been respectively received through the first tuner 310 and the second tuner 320, exceeds the predetermined threshold value, the DMB apparatus 300 outputs the video 315 and stores the data 315. In contrast, since the reception sensitivity of the content 335, which has been received through the third tuner 330, does not exceed the predetermined threshold value, the DMB apparatus 300 performs only the reception sensitivity confirmation. Therefore, where the reception sensitivities of the video 315 and the data 325 respectively received through the first tuner 310 and the second tuner 320 do not exceed the predetermined threshold value, the DMB apparatus 300 does not perform the video output and the data storage from the tuners 310, 320 and confirms only the reception sensitivity for the video 315 and the data 325.

While not required in all aspects, the threshold value can be determined by the user. At this time, the threshold value can be determined on the basis of the bit error ratio (BER). That is, the user may set the threshold value to a minimum bit error ratio 10⁻² that is suggested by a DMB standard. Alternatively, the user may set the threshold value to a bit error ratio different from the minimum bit error ratio 10⁻² according to the DMB standard. Lastly, it is understood that the threshold can be automatically selected and/or set to default such that the user need not set the threshold.

The reception sensitivity is confirmed in real time by the DMB apparatus 300. If the reception sensitivity that does not exceed the threshold value later exceeds the threshold value, the DMB apparatus 300 performs a function for the corresponding digital multimedia broadcasting signal (outputs or stores the digital multimedia broadcasting signal) or outputs a notification message using an additional notification message. For example, when the reception sensitivity for the specific video is weak, the user that wants to view the specific video can view another video or listen to another audio in a state in which the user reserves the output of the specific video. Therefore, the DMB apparatus 300 confirms the reception sensitivity of the specific video in real time while outputting another video or audio. If the reception sensitivity of the specific video later exceeds the threshold value, the DMB apparatus outputs the specific video or an additional notification message after interrupting the output of another video. Further, the user can confirm the reception sensitivity of another broadcasting signal which the user wants to view while continuously viewing the currently watched video.

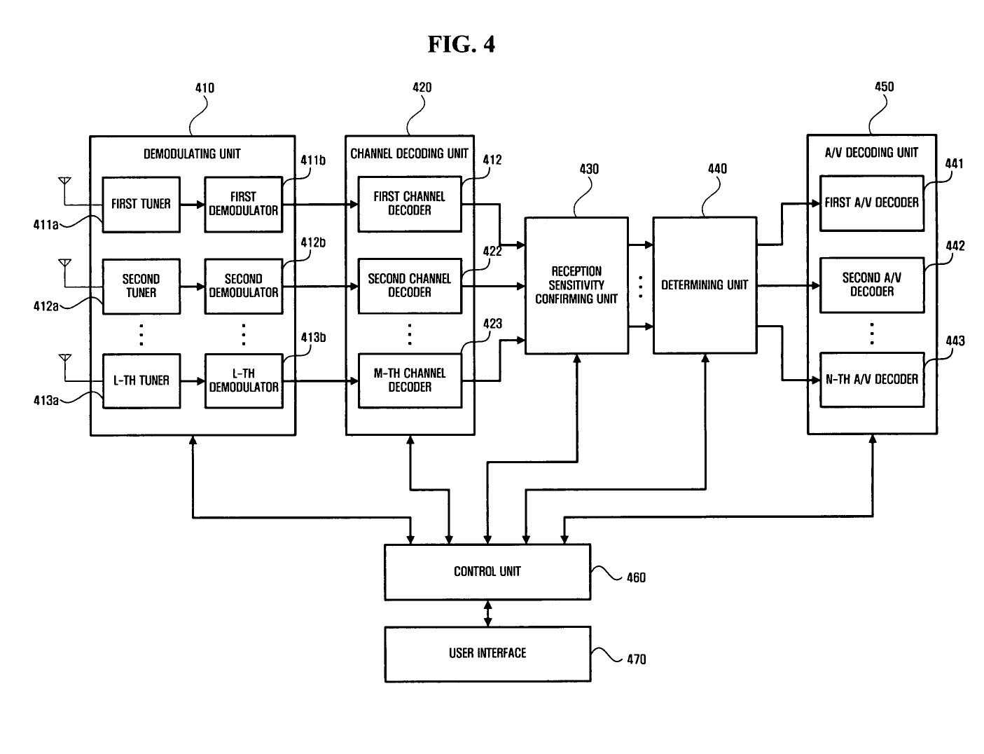

FIG. 4 is a block diagram illustrating an apparatus for providing a supplementary function of digital multimedia broadcasting according to an embodiment of the invention. The DMB apparatus 300 includes a demodulating unit 410, a channel decoding unit 420, a reception sensitivity confirming unit 430, a determining unit 440, an A/V decoding unit 450, a control unit 460, and a user interface 470. The control unit 460 serves to receive a selected instruction message for a digital multimedia broadcasting signal, such as is input by the user. The user can input the selected instruction message by using the user interface 470. The selected instruction message input by the user is transmitted to the control unit 460.

The user can select a specific ensemble which the user wants to view or listen to and sub-channels included in the specific ensemble. According to the aspect of the inventor, the user may select a plurality of ensembles. For example, the user can select a moving picture channel of a first ensemble for viewing a moving picture while selecting a data providing channel of a second ensemble for receiving data.

In accordance with the selected instruction message, the control unit 460 controls the demodulating unit 410, the channel decoding unit 420, the reception sensitivity confirming unit 430, the determining unit 440, the A/V decoding unit 450, and the user interface 470. However, it is understood that the control unit 460 can control other aspects of the DMB apparatus 300. After the control unit 460 receives the selected instruction message from the user interface 470, the control unit 460 transmits the received selected instruction message to the demodulating unit 410 and the determining unit 440. In addition, after the control unit 460 receives the audio or video data from the A/V decoding unit 450, the control unit 460 transmits the audio or video data to the user interface 470. However, it is understood that the audio and/or video can be output to separate displays and/or speakers in other aspects of the invention.

The demodulating unit 410 receives a digital multimedia broadcasting signal corresponding to the selected instruction message by using at least one of the tuners 411a, 412a, and 413a. While not required in all aspects, the shown demodulating unit 410 has tuners 411a, 412a, and 413a, and demodulators 411b, 412b, and 413b. Each of the tuners 411a, 412a, and 413a tunes to a frequency corresponding to the selected instruction message received from the control unit 460 so as to receive the digital multimedia broadcasting signal. In this example, since the demodulating unit 410 is provided with a plurality of different tuners 411a, 412a, and 413a, the demodulating unit 410 can receive a plurality of digital multimedia broadcasting signals which tune with a plurality of different frequencies, respectively.

The demodulating unit 410 includes the demodulators 411b, 412b, and 413b that respectively correspond to the respective tuners 411a, 412a, and 413a. Therefore, the digital multimedia broadcasting signals that are received by the tuners 411a, 412a, and 413a are demodulated by the corresponding demodulators 411b, 412b, and 413b. Each of the demodulators 411b, 412b, and 413b serves to extract an original digital multimedia broadcasting signal from a modulated wave.

While not required in all aspects, one or more of the demodulators 411b, 412b, and 413b may have an automatic gain control amplifying section, an oscillation section, an A/D converting section, a symbol recovering section, and/or a channel decoding section. The automatic gain control amplifying section serves to compensate for signal gain so as to convert the transmitted broadcasting signal into a signal capable of performing A/D conversion. That is, if the received broadcasting signal is weak, the automatic gain control amplifying section amplifies the output of the broadcasting signal so as to perform normal A/D conversion. The oscillation section generates a sampling frequency for sampling the transmitted broadcasting signal. The A/D converting section converts the broadcasting signal amplified by the automatic gain control amplifying section into a digital signal in accordance with the sampling frequency generated by the oscillating section.

The broadcasting signal, which is converted into the digital signal in the above-described manner, is transmitted to the symbol recovering section. The symbol recovering section receives timing errors of current symbols created by a base band signal process and reduces errors between the digital signals transmitted from the A/D converting section. Then, after a phase noise and interference between symbols are removed, the signal is transmitted to the channel decoding section. The channel decoding section restores synchronous signals inserted at the time of signal transmission from the base band signals, and restores the received data (that is, the digital multimedia broadcasting signals) by using the restored synchronous signals.

While not required in all aspects of the invention, one or more of the demodulators 411b, 412b, and 413b are orthogonal frequency division multiplex (OFDM) demodulators. Therefore, each of the demodulators 411b, 412b, and 413b divides one channel into multiple narrow-band sub-channels. Then, each of the demodulators 411b, 412b, and 413b allocates multiple sub-carrier waves that are orthogonal to one another to the respective narrow-band channels, and then modulates the waves so as to be multiplexed.

The digital multimedia broadcasting signal, which has been demodulated by the demodulating unit 410, is transmitted to the channel decoding unit 420. The channel decoding unit 420 serves to remove a transmission error that is included in the transmitted digital multimedia broadcasting signal. The channel decoding unit 420 receives a plurality of digital multimedia broadcasting signals that are transmitted from the demodulating unit 410 that includes the plurality of tuners 411a, 412a, and 413a, and the plurality of demodulators 411b, 412b, and 413b. Therefore, as shown in FIG. 4, the channel decoding unit 420 has corresponding channel decoders 421, 422, and 423. While not required in all aspects, one or more of the channel decoder channel decoders 421, 422, and 423 removes transmission errors of the digital multimedia broadcasting signals in transmitted order.

The digital multimedia broadcasting signals whose errors are removed are transmitted to the reception sensitivity confirming unit 430. The reception sensitivity confirming unit 430 confirms the reception sensitivity of each of the transmitted digital multimedia broadcasting signals. In this example, the reception sensitivity confirming unit 430 can confirm the reception sensitivity by using bit error ratios of the received digital multimedia broadcasting signals. However, other methods can be used to detect the sensitivity.

The confirmed reception sensitivity is transmitted to the determining unit 440. The determining unit 440 determines whether the received digital multimedia broadcasting signals are output in accordance with the confirmed reception sensitivity. That is, the determining unit 440 determines the output of the received digital multimedia broadcasting signal having the confirmed reception sensitivity which exceeds the predetermined threshold value. In this embodiment, the threshold value may be determined in accordance with the bit error ratio, and the user may set the threshold value.

The digital multimedia broadcasting signal whose output has been determined by the determining unit 440 is transmitted to the A/V decoding unit 450. The audio and video are decoded at the decoding unit 440. In this case, a plurality of digital multimedia broadcasting signals may be transmitted from the determining unit 440. While not required in all aspects, the A/V decoding unit 450 has a plurality of A/V decoders 441, 442, and 443. Each of A/V decoders 441, 442, and 443 may perform audio and video decoding for the digital broadcasting signals in a transmitted order. However, it is understood that other types of decoders can be used such as those suitable for encoded non- audio/video data, and that decoders need not be used where the encoded data is not being reproduced.

While not required in all aspects, the user interface 470 includes an input unit and an output unit. The input unit serves to be input with a selected instruction message for a digital multimedia broadcasting signal from a user. The user may input the selected instruction message by using input units, such as buttons, touch pads, touch screens, click wheels or the like. The output unit of the user interface 470 serves to output an audio or video. However, it is understood that both input and output units need not both be used, and that the input and output units need not be combined in a single interface in all aspects of the invention. Additionally, one or both of the input and output units can be connected to the apparatus 300, and or can be integrally provided in a common housing with the apparatus 300.

When the determining unit 440 among the digital multimedia broadcasting signals is selected in accordance with the selected instruction messages input by the user, the output unit may output a notification message indicating that the digital multimedia broadcasting signal determined by the determining unit 440 exists among them. That is, when the reception sensitivity of the desired digital multimedia broadcasting signal is less than the predetermined value, the user may view a digital multimedia broadcasting signal of another frequency while maintaining the current setting state. At this time, if the reception sensitivity of the set digital multimedia broadcasting signal exceeds the predetermined value, the user can recognize the reception sensitivity of the digital multimedia broadcasting signal that is not viewing through the notification message output from the output unit.

While not required in all aspects, the output unit has an audio output unit (such as a speaker, a headphone jack, a stereo connection, etc.). The output unit also includes a video output unit that can output a video. The video output unit corresponds to a module that has a video display unit, which can be as a cathode ray tube (CRT), a liquid crystal display (LCD), a light-emitting diode (LED), an organic light-emitting diode (OLED), a plasma display panel (PDP), or the like. The video display unit displays input video signals, and serves to display transmitted video information.

In addition and while not required in all aspects, the DMB apparatus 300 may include a storing unit (not shown) that can store data among the digital multimedia broadcasting signals whose output is determined by the determining unit 440. Such a storing unit can be a magnetic or optical media, a flash memory, or combination thereof. Further, the storing unit can be utilized to further store the video and/or audio data for delayed playback in other embodiments. Also, the storing unit need not be included in the apparatus, and can instead be connected to the apparatus 300 through a data interface (not shown) directly or across one or more networks.

FIG. 5 is a diagram illustrating a selected instruction message according to an embodiment of the invention. The shown selected instruction message 500 has an ensemble-type field 510, a sub-channel field 520, a reception sensitivity confirmation field 530, a bit error ratio field 540, a notification message field 550, and a reservation field 560. The ensemble-type field 510 indicates a type of an ensemble that is supplied by a specific digital multimedia broadcasting provider. The sub-channel field 520 indicates one of sub-channels that are included in the selected ensemble. That is, the user receives a video, an audio or data by selecting the sub-channel indicated in the field 520 and allows the DMB apparatus 300 to perform the corresponding function.

The reception sensitivity confirmation field 530 is input with a flag indicating whether the reception sensitivity has been confirmed with respect to the sub-channel included in the selected ensemble. That is, the reception sensitivity confirmation field 530 includes a value of 0 or 1. If a value of 0 is in the reception sensitivity confirmation field 530, the DMB apparatus 300 does not confirm the reception sensitivity for a sub-channel included in the corresponding ensemble. In contrast, if a value of 1 is in the reception sensitivity confirmation field 530, the DMB apparatus 300 confirms the reception sensitivity for a sub-channel included in the corresponding ensemble. If a value of 0 is input to the reception sensitivity confirmation field 530, values input to subsequent fields (that is, the bit error ratio field 540, the notification message field 550, and the reservation field 560) can be ignored.

The bit error ratio field 540 is input with the above-described threshold value. That is, the threshold value, which is input to the bit error ratio field 540, is used in determining whether performed is a job for the digital multimedia broadcasting which is selectively receiving (broadcasting is output or a notification message is output). The notification message field 550 is input with a flag indicating whether a notification message is output. The notification message is a message output for informing, when the reception sensitivity for the sub-channel that is included in the selected ensemble exceeds the bit error ratio input to the bit error ratio field 540, the user of this state. A value of 0 or 1 may be input to the notification message field 550. In this case, if a value of 0 is input to the notification message field 550, the DMB apparatus 300 does not output the notification message, and when a value of 1 is input to the notification message field 550, the DMB apparatus 300 outputs the notification message.

The reservation field 560 is input with reception sensitivity confirmation time for a sub-channel of a specific ensemble that becomes a reception sensitivity confirmation subject and whether a corresponding job is performed or not. For example, the user can input starting time and completing time to the reservation field 560. If the set time is input to the reservation field 560, the DMB apparatus 300 confirms the reception sensitivity for only the set time. If the set time passes away, the DMB apparatus 300 completes the reception sensitivity confirmation. Therefore, the DMB apparatus 300 does not perform unnecessary operation.

In the meantime, whether the job is performed or not indicates, which is in the reservation field 560, indicates whether the corresponding digital multimedia broadcasting is performed or not. This indication may be through a value of 0 or 1 may be input. That is, if a value of 0 is in the field 560 in regard to whether the job is performed or not, even though the reception sensitivity exceeds a threshold value, the DMB apparatus 300 does not perform an additional job. If a value of 1 is in the field 560 in regard to whether the job is performed or not, when the reception sensitivity exceeds a threshold value, the DMB apparatus 300 performs jobs, such as output or storage. However, it is understood that fields 540, 550, and/or 560 need not be used in all aspects, such as when the bit error ratio and/or message are predetermined or part of a standard.

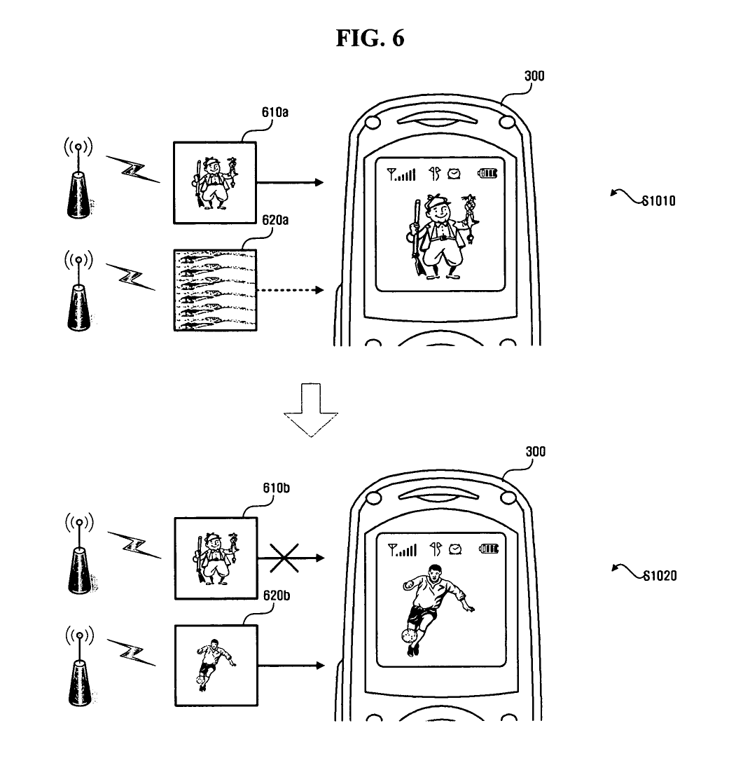

FIG. 6 is a diagram illustrating types in which digital multimedia broadcasting is output in accordance with an embodiment of the invention. The DMB apparatus 300 can receive one or more digital multimedia broadcasting signals in accordance with the selected instruction message 500 that has been input by the user. FIG. 6 is a diagram illustrating the DMB apparatus 300 that receives two digital multimedia broadcasting signals: a first content 610a and a second content 620a. The DMB apparatus 300 performs a function that is divided into a first step (S1010) and a second step (S1020).

In the first step (S1010), the DMB apparatus 300 receives a first content 610a and a second content 620a in accordance with the selected instruction message 500 that has been input by the user. In this case, the content which the user actually wants to view is the second content 620a. However, since the reception sensitivity of the second content 620a does not exceed the predetermined reception sensitivity, the DMB apparatus 300 confirms the reception sensitivity of the second content 620a in real time while displaying only the first content 610a. Then, if the reception sensitivity of the second content 620a exceeds the predetermined reception sensitivity, the process proceeds to the second step (S1020). In the second step (S1020), the DMB apparatus 300 stops the display of the first content 610b, and displays the second content 620b. That is, the DMB apparatus 300 automatically switches the displayed screen to second content 620b without an additional notification message. Therefore, while the user views the digital multimedia broadcasting which the user selects as the next best digital multimedia broadcasting which the user wants to view, the user can quickly view the digital multimedia broadcasting which is selected as the best digital multimedia broadcasting which the user wants to view. While shown as replacing the display of the first content 610b with the second content 620b, it is understood that the display could be of both the first and second contents 610b, 620b, such as in a picture-in-picture display.

In this example, after the screen is converted, if the reception sensitivity of the digital multimedia broadcasting selected as the best digital multimedia broadcasting which the user wants to view (i.e. the reception sensitivity of the second content 620b) reaches a threshold value or less, the DMB apparatus 300 can confirm the reception sensitivity of the second content 620b while displaying the first content 610b having been displayed before displaying the second content 620b.

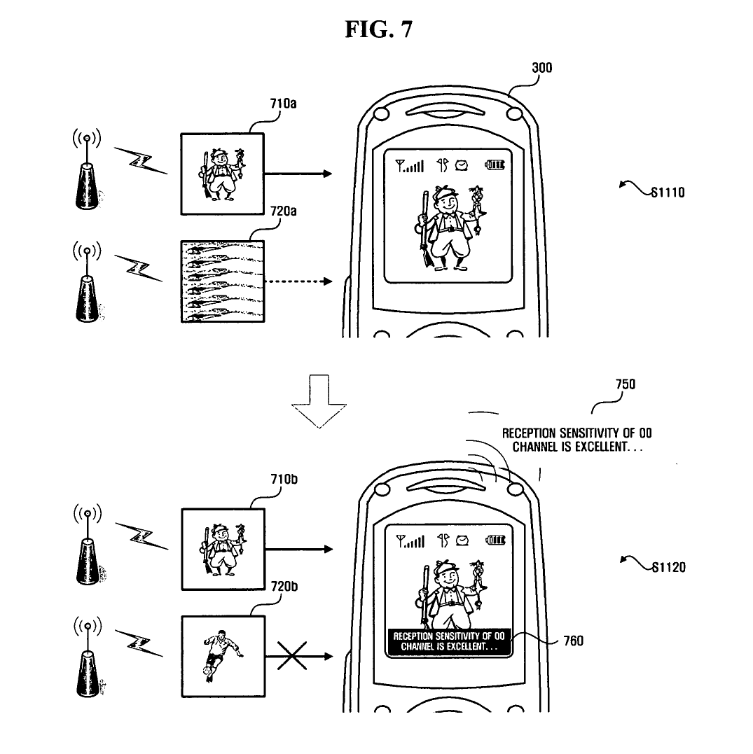

FIG. 7 is a diagram illustrating various types in which notification messages are output in accordance with an embodiment of the invention. The DMB apparatus 300 can receive one or more digital multimedia broadcasting signals in accordance with the selected instruction message 500 that has been input by the user. FIG. 7 is a diagram illustrating the DMB apparatus 300 that receives two digital multimedia broadcasting signals including a first content 710a and a second content 720a The DMB apparatus 300 performs a function that is divided into a first step (S1110) and a second step (S1120).

In the first step (S1110), the DMB apparatus 300 receives a first content 710a and a second content 720a in accordance with the selected instruction message 500 that has been input by the user. In this example, the content, which the user actually wants to view is the second content 720a. However, since the reception sensitivity of the second content 720a does not exceed the predetermined reception sensitivity, the DMB apparatus 300 confirms the reception sensitivity of the second content 720a in real time while displaying only the first content 710a. Then, if the reception sensitivity of the second content 720a exceeds the predetermined reception sensitivity, the process proceeds to the second step (S1120). In the second step (S1120), the DMB apparatus 300 outputs a notification message (750 or 760) through an output unit while maintaining the display of the first content 710b. That is, the DMB apparatus 300 outputs through the audio or video a message (750 or 760) that the reception sensitivity of the second content 720b is excellent. Therefore, while the user views the digital multimedia broadcasting which the user selects as the next best digital multimedia broadcasting which the user wants to view, the user can determine when to perform the screen conversion for converting the digital multimedia broadcasting selected as the next best digital broadcasting (i.e., content 710b) into the digital multimedia broadcasting selected as the best digital broadcasting which the user wants to view (i.e., content 720b).

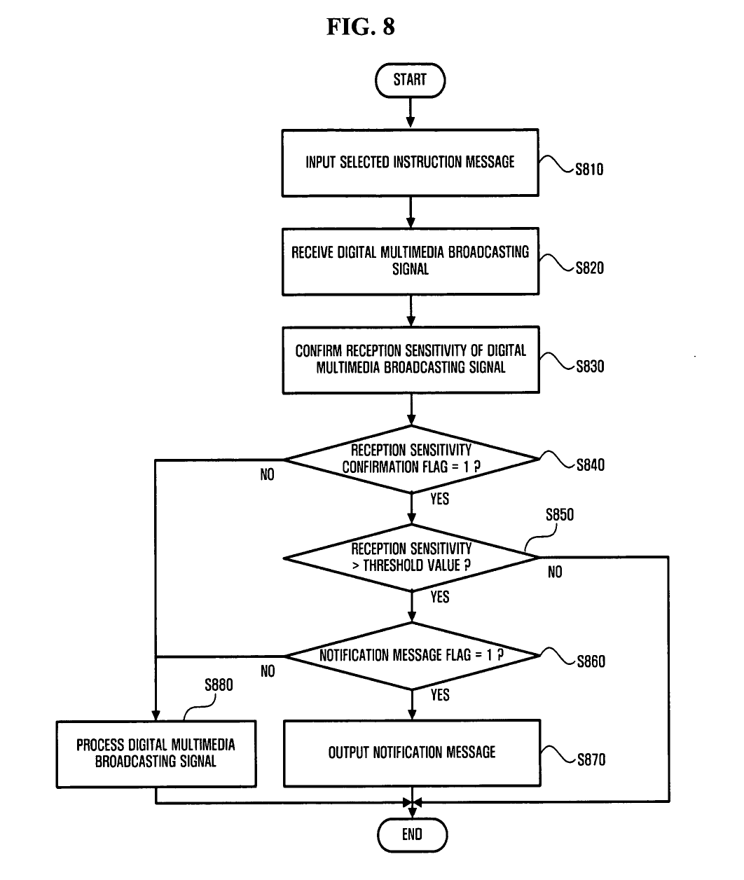

FIG. 8 is a flowchart illustrating a process for supplying a supplementary function of digital multimedia broadcasting according to an embodiment of the invention. In order to provide a supplementary function of digital multimedia broadcasting, the DMB apparatus 300 receives the selected instruction message 500 that has been input by the user through the user interface 470 (S810). In this case, the selected instruction message 500 may include information, such as an ensemble-type field 510, a sub-channel field 520, a reception sensitivity confirmation field 530, a bit error ratio field 540, a notification message field 550, and a reservation field 560. While described as being input by a user, it is understood that the input can be from other sources, such as an output of a program.

The selected instruction message 500 is transmitted to the control unit 460, and the control unit 460 controls the demodulating unit 410, the channel decoding unit 420, the reception sensitivity confirming unit 430, the determining unit 440, and the A/V decoding unit 450 in accordance with the selected instruction message 500. The control unit 460 transmits the ensemble-type and the sub-channel included in the selected instruction message 500 to the demodulating unit 410. Then, the decoding unit 410 receives the digital multimedia broadcasting signal corresponding to the selected instruction message 500 while using at least one of the tuners 411a, 412a, and 413a (S820).

While not required in all aspects, the shown decoding unit 410 has different tuners 411a, 412a, and 413a, and different demodulators 411b, 412b, and 413b. The tuners 411a, 412a, and 413a receive the digital multimedia broadcasting signals, and the demodulators 411b, 412b, and 413b demodulate the received digital multimedia broadcasting signals. The digital multimedia broadcasting signal, which has been demodulated by the demodulating unit 410, is transmitted to the channel decoding unit 420. The channel decoding unit 420 removes a transmission error that is included in the transmitted digital multimedia broadcasting signal. In this example and while not required in all aspects, the channel decoding unit 420 removes a transmission error included in the digital multimedia broadcasting signal by using at least one channel decoder. Then, the digital broadcasting signals whose errors are removed are transmitted to the reception sensitivity confirming unit 430, and the reception sensitivity confirming unit 430 confirms the reception sensitivity of each of the transmitted digital multimedia broadcasting signals (S830).

In this example and while not required in all aspects, the reception sensitivity confirming unit 430 confirms a bit error ratio of the received digital multimedia broadcasting signal so as to confirm the reception sensitivity thereof. The confirmed reception sensitivity (the bit error ratio) is transmitted to the determining unit 440. The determining unit 440 determines whether the received digital multimedia broadcasting signals are output. At this time, the determining unit 440 determines whether the received digital multimedia broadcasting signals are output in accordance with the selected instruction message 500. That is, the determining unit 440 confirms the reception sensitivity confirmation field 530 of the selected instruction message 500 (S840).

If the reception sensitivity confirmation flag is set to 0, the determining unit 440 ignores the reception sensitivity transmitted from the reception sensitivity confirming unit 430, and allows the received digital multimedia broadcasting signal to be processed (S880). Therefore, the audio or video digital multimedia broadcasting signal is transmitted to the A/V decoding unit 450, then subjected to an audio or video decoding process, and then output through the user interface 470. Then, the digital multimedia broadcasting signal of the data is stored in a storing unit (not shown) that is included in the DMB apparatus 300.

If the reception sensitivity confirming flag is set to 1, the determining unit 440 confirms whether the reception sensitivity exceeds the predetermined threshold value (S850). That is, the determining unit 440 compares the bit error ratio included in the selected instruction message 500 with the bit error ratio transmitted from the reception sensitivity confirming unit 430. At this time, if the bit error ratio transmitted from the reception sensitivity confirming unit 430 is larger than the bit error ratio included in the selected instruction message 500, the determining unit 440 confirms the notification message field 550 included in the selected instruction message 500 (S860).

If the notification message flag is set to 0, the determining unit 440 determines the output of the received digital multimedia broadcasting signal, and allows the received digital multimedia broadcasting signal to be processed (S880). Therefore, the audio or video digital multimedia broadcasting signal is transmitted to the A/V decoding unit 450, then subjected to an audio or video decoding process, and then output through the user interface 470. Then, the digital multimedia broadcasting signal of the data is stored in a storing unit (not shown) that is included in the DMB apparatus 300.

If the notification message flag is set to 1, the determining unit 440 reserves the output of the received digital multimedia broadcasting signal, and waits for an instruction of the control unit 460. Then, the user interface 470 outputs a notification message in accordance with the instruction of the control unit 460. That is, the user interface 470 outputs the audio or video notification message (S870). However, it is understood that if no notification message is to be displayed, such as where an automatic change is specified as in FIG. 6, S860 and/or S870 need not be performed.

While not restricted thereto, it is understood that the DMB apparatus 300 can be implemented using portable devices, such as telephones, personal digital assistants, and portable media players; non-portable devices such as displays, personal computers, audio and/or video recording and/or reproducing apparatuses, and digital video recorders; or combinations thereof.

While not limited thereto, aspects of apparatus for providing a supplementary function of digital multimedia broadcasting according to the invention and a method of the same can achieve one or more of the following effects. According to one effect of the prevention invention, a plurality of contents that are included in different ensembles can be provided by using a plurality of tuners. According to another effect of the present invention, the reception sensitivity of another ensemble that does not include the content can be measured by using another tuner that is not currently used for content reception, and when the measured reception sensitivity is greater than a predetermined threshold value, it is possible to inform a user that the measured reception sensitivity is greater than the specific threshold value.

Although the present invention has been described in connection with the exemplary embodiments of the present invention, it will be apparent to those skilled in the art that various modifications and changes may be made thereto without departing from the scope and spirit of the invention as defined in the claims and equivalents thereof. Therefore, it should be understood that the above embodiments are not limitative, but illustrative in all aspects.

What is claimed is:

1. An apparatus for providing a supplemental function of digital multimedia broadcasting, comprising:
a control unit that receives a selected instruction message for a digital multimedia broadcasting signal input by a user;
a demodulating unit that receives a digital multimedia broadcasting signal corresponding to the received instruction message using at least one tuner;
a reception sensitivity confirming unit that confirms a reception sensitivity of the received digital multimedia broadcasting signal; and
a determining unit that determines whether to output the received digital multimedia broadcasting signal according to the confirmed reception sensitivity.

2. The apparatus of claim 1, wherein the selected instruction message includes an ensemble-type field, a sub-channel field, a reception sensitivity confirming field, a bit error ratio field, a notification message field, a reservation field, or combinations thereof.

3. The apparatus of claim 1, wherein the reception sensitivity confirming unit confirms the reception sensitivity using a bit error ratio of the received digital multimedia broadcasting signal.

4. The apparatus of claim 1, wherein the determining unit determines to output the received digital multimedia broadcasting signal when the confirmed reception sensitivity exceeds a predetermined threshold value.

5. The apparatus of claim 4, further comprising an audio and/or video decoding unit that decodes audio data and/or video data in the digital multimedia broadcasting signal whose output has been determined by the determining unit.

6. The apparatus of claim 1, further comprising an interface unit that receives the selected instruction message and outputs, after decoding, the received digital multimedia broadcasting signal.

7. A method of providing a supplemental function of digital multimedia broadcasting, comprising:
receiving a selected instruction message for a digital multimedia broadcasting signal input by a user;
using at least one tuner to receive a digital multimedia broadcasting signal corresponding to the received instruction message;
confirming a reception sensitivity of the received digital multimedia broadcasting signal; and
determining whether to output the received digital multimedia broadcasting signal according to the confirmed reception sensitivity.

8. The method of claim 7, wherein the selected instruction message includes an ensemble-type field, a sub-channel field, a reception sensitivity confirming field, a bit error ratio field, a notification message field, a reservation field, or combinations thereof.

9. The method of claim 7, wherein the confirming the reception sensitivity includes using a bit error ratio of the received digital multimedia broadcasting signal to confirm the reception sensitivity.

10. The method of claim 7, wherein the determining whether to output the received digital multimedia broadcasting signal includes determining to output the received digital multimedia broadcasting signal when the confirmed reception sensitivity exceeds a predetermined threshold value.

11. The method of claim 10, further comprising, for the digital multimedia broadcasting signal determined to be output, decoding an audio data and a video data included in the digital multimedia broadcasting signal.

12. The method of claim 7, further comprising:
receiving the selected instruction message; and
outputting, after decoding, the received digital multimedia broadcasting signal.

13. A digital multimedia broadcast terminal, comprising:
a first tuner that tunes a first digital multimedia broadcasting signal;
a second tuner that tunes a second digital multimedia broadcasting signal having a reception characteristic; and
a reception evaluation unit which compares a threshold with the reception characteristic, and based upon the comparison:
prevents an output of the tuned second digital multimedia broadcasting signal while the reception characteristic is below the threshold while allowing an output of the tuned first digital multimedia broadcasting signal, and
allows the output of the tuned second digital multimedia broadcasting signal after the reception characteristic is at or exceeds the threshold in addition to allowing the output of the tuned first digital multimedia broadcasting signal.

14. The digital multimedia broadcast terminal of claim 13, further comprising an output unit, wherein after the reception characteristic is at or exceeds the threshold, the reception evaluation unit provides a message indicating that the tuned second digital multimedia broadcasting signal can be output, and, if the tuned second digital multimedia broadcasting signal is selected to be output after providing the message, allows the tuned second digital multimedia broadcasting signal to be output through the output unit.

15. The digital multimedia broadcast terminal of claim 14, wherein when the tuned second digital multimedia broadcasting signal is selected to be output after providing the message, the reception evaluation unit replaces the tuned first digital multimedia broadcasting signal being output through the output unit with the tuned second digital multimedia broadcasting signal.

16. The digital multimedia broadcast terminal of claim 14, wherein:
the output unit is a display on which the tuned first digital multimedia broadcasting signal is displayed, and
after providing the message through the display, the reception evaluation unit replaces the tuned first digital multimedia broadcasting signal being displayed with the tuned second digital multimedia broadcasting signal to display the tuned second digital multimedia broadcasting signal on the display.

17. The digital multimedia broadcast terminal of claim 13, further comprising an output unit which outputs the tuned first digital multimedia broadcasting signal prior to the reception characteristic being at or exceeding the threshold, wherein after the reception characteristic is at or exceeds the threshold, the reception evaluation unit automatically outputs the tuned second digital multimedia broadcasting signal through the output unit.

18. The digital multimedia broadcast terminal of claim 13, further comprising an output unit which outputs the tuned first digital multimedia broadcasting signal prior to the reception characteristic being at or exceeding the threshold, wherein after the reception characteristic is at or exceeds the threshold, the reception evaluation unit automatically replaces the tuned first digital multimedia broadcasting signal being output through the output unit with the tuned second digital multimedia broadcasting signal through the output unit.

19. The digital multimedia broadcast terminal of claim 18, wherein:
the output unit is a display on which the tuned first digital multimedia broadcasting signal is displayed, and
the reception evaluation unit replaces the tuned first digital multimedia broadcasting signal being displayed with the tuned second digital multimedia broadcasting signal to display the tuned second digital multimedia broadcasting signal on the display.

20. The digital multimedia broadcast terminal of claim 13, wherein the reception evaluation unit receives an instruction message which sets the threshold for the second digital multimedia broadcasting signal.

21. The digital multimedia broadcast terminal of claim 20, wherein the instruction message further identifies the second digital multimedia broadcasting signal to be output when the reception characteristic is above the threshold.

22. The digital multimedia broadcast terminal of claim 13, wherein the first and second digital multimedia broadcasting signals comprise corresponding first and second ensembles within a channel of a digital multimedia broadcast.

23. The digital multimedia broadcast terminal of claim 22, wherein the first and second ensembles are sub-channels within a frequency band defining the channel of the digital multimedia broadcast.

24. The digital multimedia broadcast terminal of claim 22, wherein:
the reception evaluation unit receives an instruction message which sets the threshold for the second digital multimedia broadcasting signal, and
the instruction message includes:
a sub-channel field selectable between a video data and a non-video data in the second digital multimedia broadcasting signal,
a reception sensitivity confirming field selectable between an enable state allowing the reception evaluation unit to restrict output based upon the threshold and a disable state preventing the reception evaluation unit from restricting output based upon the threshold,
a bit error ratio field setting the threshold,
a notification message field indicating a message to be output when the threshold is exceeded,
a reservation field defining an extent of time the reception evaluation unit compares the compares the threshold with the second reception characteristic, or
combinations thereof.

25. A method of tuning a digital multimedia broadcast, comprising:
while outputting a first digital multimedia broadcasting signal, tuning a second digital multimedia broadcasting signal having a reception characteristic;
comparing a threshold with the reception characteristic;
preventing an output of second digital multimedia broadcasting signal while the reception characteristic is below the threshold while allowing output of the first digital multimedia broadcasting signal; and
allowing the output of tuned second digital multimedia broadcasting signal while the reception characteristic is at or above the threshold in addition to allowing the output of the first digital multimedia broadcasting signal.

26. The method of claim 25, further comprising receiving the first digital multimedia broadcasting signal at a first tuner, wherein the tuning the second digital multimedia broadcasting signal comprising receiving the second digital multimedia broadcasting signal at a second tuner other than the first tuner.

27. The method of claim 25, further comprising, after the reception characteristic is at or above the threshold, providing a message indicating that the tuned second digital multimedia broadcasting signal can be output.

28. The method of claim 27, further comprising, after providing the message, selecting the tuned second digital multimedia broadcasting signal to be output through an output unit.

29. The method of claim 28, wherein after selecting the tuned second digital multimedia broadcasting signal, replacing the first digital multimedia broadcasting signal being output through the output unit with the tuned second digital multimedia broadcasting signal.

30. The method of claim 28, wherein the output unit is a display on which the first digital multimedia broadcasting signal is displayed prior to selecting the tuned second digital multimedia broadcasting signal, and the method further comprises, after selecting the tuned second digital multimedia broadcasting signal, replacing the first digital multimedia broadcasting signal being displayed with the tuned second digital multimedia broadcasting signal to display the tuned second digital multimedia broadcasting signal on the display.

31. The method of claim 25, further comprising:
outputting through an output unit the first digital multimedia broadcasting signal prior to the reception characteristic being is at or above the threshold, and
after the reception characteristic is at or above the threshold, automatically outputting the tuned second digital multimedia broadcasting signal through the output unit.

32. The method of claim 25, further comprising:
outputting through an output unit the first digital multimedia broadcasting signal prior to the reception characteristic being is at or above the threshold, and
after the reception characteristic is at or above the threshold, the automatically replacing the first digital multimedia broadcasting signal being output through the output unit with the tuned second digital multimedia broadcasting signal through the output unit.

33. The method of claim 25, further comprising setting the threshold according to a received instruction message for the second digital multimedia broadcasting signal.

34. The method of claim 33, wherein the instruction message further identifies the second digital multimedia broadcasting signal to be output when the reception characteristic is at or above the threshold.

35. The method of claim 25, wherein the first and second digital multimedia broadcasting signals comprise corresponding first and second ensembles within a channel of a digital multimedia broadcast.

36. The method of claim 35, wherein the first and second ensembles are sub-channels within a frequency band defining the channel of the digital multimedia broadcast.

37. The method of claim 35, wherein:
the reception evaluation unit receives an instruction message which sets the threshold for the second digital multimedia broadcasting signal, and
the instruction message includes:
a sub-channel field selectable between a video data and a non-video data in the second digital multimedia broadcasting signal,
a reception sensitivity confirming field selectable between an enable state allowing output restriction based upon the threshold and a disable state preventing the output restriction based upon the threshold,
a bit error ratio field setting the threshold,
a notification message field indicating a message to be output when the threshold is exceeded,
a reservation field defining an extent of time the threshold is compared with the reception characteristic, or
combinations thereof.

38. A computer readable medium encoded with a method of tuning a digital multimedia broadcast of claim 25 implemented by one or more computers.
